(19) United States
(12) Patent Application Publication
(10) Pub. No.: US 2023/0294298 A1
(43) Pub. Date: Sep. 21, 2023

(54) HAPTIC FEEDBACK SYSTEMS USING ONE OR MORE ROBOTIC ARMS

(71) Applicant: Flexiv Ltd., Grand Cayman (KY)

(72) Inventors: Peizhang Zhu, San Jose, CA (US); Xiyang Yeh, San Jose, CA (US); Zhan Fan Quek, Singapore (SG)

(21) Appl. No.: 17/699,360

(22) Filed: Mar. 21, 2022

(51) Int. Cl. B25J 13/02; B25J 13/08; B25J 9/16

(52) U.S. Cl. CPC B25J 13/025; B25J 13/085; B25J 9/1633; B25J 9/1664

(57) ABSTRACT

Methods and systems for improved haptic feedback using robotic arms are provided. In one embodiment, a haptic feedback system is provided that includes one robotic arm with at least one joint and one end effector. The end effector may be physically coupled to a user. The system may further include an external data connection to a computing device associated with an environment (e.g., a virtual environment, a physical environment). A controller may then be configured to receive force and torque information via the external data connection and role robotic arm based on the force and torque information to apply haptic feedback via the end effector to a user.

### BACKGROUND

Various systems may be used to provide haptic or other physical feedback to a user. For example, haptic feedback may be provided to a user within a virtual environment, such as a three-dimensional virtual environment implemented by a computing device.

### SUMMARY

The present disclosure presents new and innovative system and methods for providing haptic feedback using one or more robotic arms. In a first aspect, a haptic feedback system is provided that includes at least one robotic arm with at least one joint and an end effector. The end effector may be physically coupled to a user. The system may also include an external data connection to a computing device associated with an environment. The system may further include a controller configured to receive pose information of the at least one robotic arm, determine an estimated pose for the user based on the pose information, and control the robotic arm based on the estimated pose to apply haptic feedback to the user via the end effector.

In a second aspect according to the first aspect, the controller is further configured to control a proxy of the user within the environment based on the estimated position.

In a third aspect according to any of the first and second aspects, the controller is further configured to receive force and torque information via the external data connection and control the robotic arm to limit at least one of a force applied to the user and a torque applied to the user.

In a fourth aspect according to the third aspect, the robotic arm further comprises sensors. Controlling the robotic arm based on the force and torque information may further include measuring at least one of a force and a torque applied to the user at the end effector using the sensors.

In a fifth aspect according to the fourth aspect, the controller is a closed-loop controller and receives data measured by the sensors.

In a sixth aspect according to any of the fourth and fifth aspects, the sensors are arranged in a series orientation.

In a seventh aspect according to any of the first through sixth aspects, the environment is a virtual environment.

In an eighth aspect according to any of the first through seventh aspects, the environment is a physical environment that is physically separated from the haptic feedback system.

In a ninth aspect according to any of the first through eighth aspects, the end effector is physically connected to the end of a limb of the user.

In a tenth aspect according to any of the first through ninth aspects, the end effector is physically connected to a garment worn by the user.

In an eleventh aspect according to a tenth aspect, the garment includes one or more of a glove, a shoe, a sleeve, a belt, a vest, a helmet, and/or a neck wrap.

In a twelfth aspect according to any of the first through eleventh aspects, the system further includes multiple robotic arms that are physically coupled to the user at multiple points.

In a thirteenth aspect according to any of the first through twelfth aspects, the end effector is capable of movement with 6 degrees of freedom.

In a fourteenth aspect according to any of the first through thirteenth aspects, the at least one robotic arm is further physically coupled to a fixed structure surrounding the user.

In a fifteenth aspect, a method is provided that includes receiving pose information from at least one robotic arm, wherein the at least one robotic arm is physically coupled to a user. The method may also include determining an estimated pose for the user based on the pose information and controlling the at least one robotic arm based on the estimated pose to apply haptic feedback to the user.

In a sixteenth aspect according to the fifteenth aspect, the controller is further configured to control a proxy of the user within an environment based on the estimated position.

In a seventeenth aspect according to the sixteenth aspect, the environment is a virtual environment.

In an eighteenth aspect according to any of the fifteenth through seventeenth aspects, the robotic arm comprises sensors. Controlling the robotic arm may include measuring at least one of a force and a torque applied to the user using the sensors.

In a nineteenth aspect according to the eighteenth aspect, the controller is a closed-loop controller and receives data measured by the sensors.

In a twentieth aspect according to any of the eighteenth and nineteenth aspects, the sensors are arranged in a series orientation.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIGS. 1-4 illustrate robotic haptic feedback systems according to an exemplary embodiment of the present disclosure.

FIG. 5 illustrates a system for controlling a robotic haptic feedback system according to an exemplary embodiment of the present disclosure.

FIG. 6 illustrates a method for controlling a robotic haptic feedback system according to an exemplary embodiment of the present disclosure.

FIG. 7 depicts a robotic arm according to an exemplary embodiment of the present disclosure.

FIG. 8 illustrates a computer system according to an exemplary embodiment of the present disclosure.

### DETAILED DESCRIPTION OF EXAMPLE EMBODIMENTS

Haptic feedback may be useful for users of various virtual environments. For example, haptic feedback may be provided (e.g., in the form of the vibrations or other physical sensations provided through a controller) to users of videogame environments in order to provide information about the virtual environment (e.g., a user proxy or character within the videogame). Furthermore, certain types of virtual environments (e.g., virtual reality environments) may also benefit from haptic feedback that differs from haptic feedback provided, e.g., during video games.

For example, when interacting with objects within a virtual reality environment, it may be beneficial to provide haptic feedback to a user, such as applying resistance to a user's limbs to prevent the user from moving beyond boundaries within the virtual reality environment (e.g., walls, object boundaries, other characters or users). Such feedback may improve immersion for users of the virtual reality environment. Such virtual reality environments may be useful for videogame applications, but may also be used in other areas (e.g., to conduct virtual meetings). In such instances, the haptic feedback may assist with interaction between users and/or product designs (e.g., allowing a user to interact with a three-dimensional product design within a virtual reality environment).

Existing haptic feedback systems typically struggle to provide haptic feedback beyond simple vibrations to users (e.g., users of a virtual reality environment). For example, existing virtual reality systems may utilize handheld controllers that vibrate to provide haptic feedback but cannot restrict movement or apply forces to a user's limbs, inhibiting the immersive and collaborative potentials of virtual reality environments. Haptic feedback systems may also be useful to users of non-virtual environments (e.g., physically separated environments), which may require physical restrictions on users to enable proper control of objects within the physical environments.

Robotics systems may be used to provide such haptic feedback. However, such systems typically require smaller, limited-use robotic arms, which reduce the output capacity of the robots. This also reduces the physical range (e.g., the size of the operating area) for such systems. Similarly, these systems typically require parallel kinematics and thus cannot be used for systems that require continuous movements. Furthermore, existing system's sensors are typically too slow for use in high-speed or quick-changing applications such as haptic feedback, which may need to respond to quick movements of a user.

One solution to this problem is to provide a haptic feedback system that utilizes full-size, industrial robotic arms to provide haptic feedback at various points on the user. The robotic arms may have an increased range (e.g., 6-feet or more) and are thus able to provide haptic feedback over a larger area. Similarly, the robotic arms may include series kinematics to operate and move the robotic arm, enabling improved force and torque output. Furthermore, the system may include high-frequency sensors, which may enable the greater responsiveness (e.g., using a closed-loop controller) that is necessary for haptic feedback applications. This system may be attached to a user at one or more locations (e.g., may connect to one or more limbs). For example, the system may attach to at least one garment worn by the user.

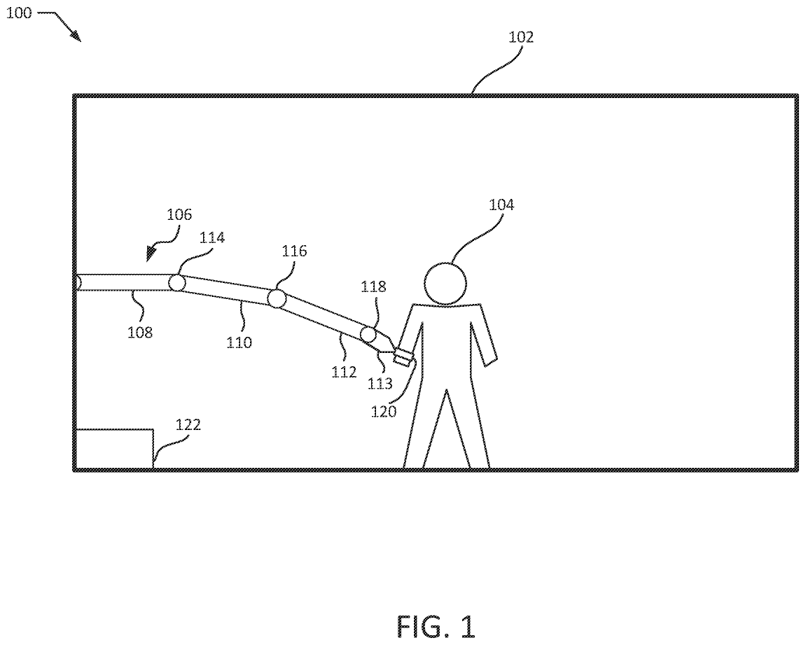

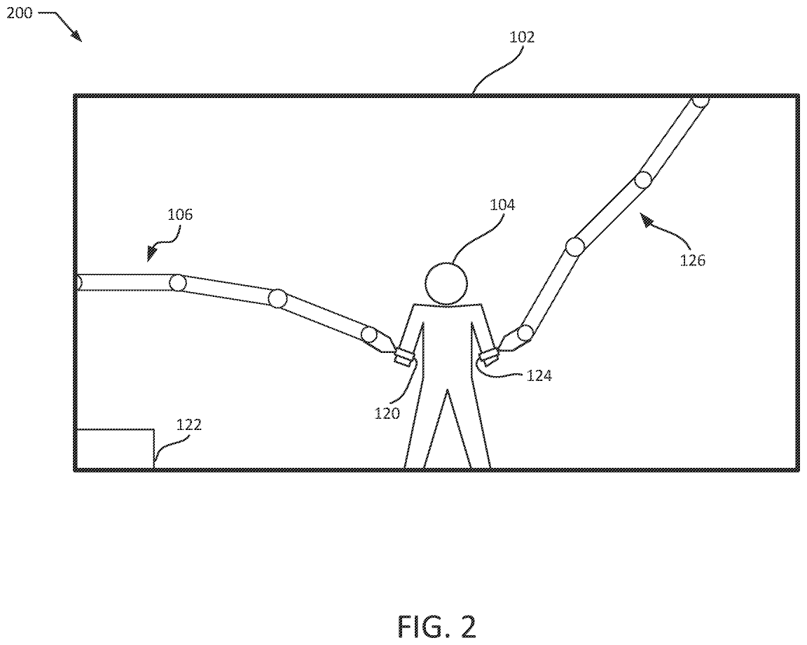

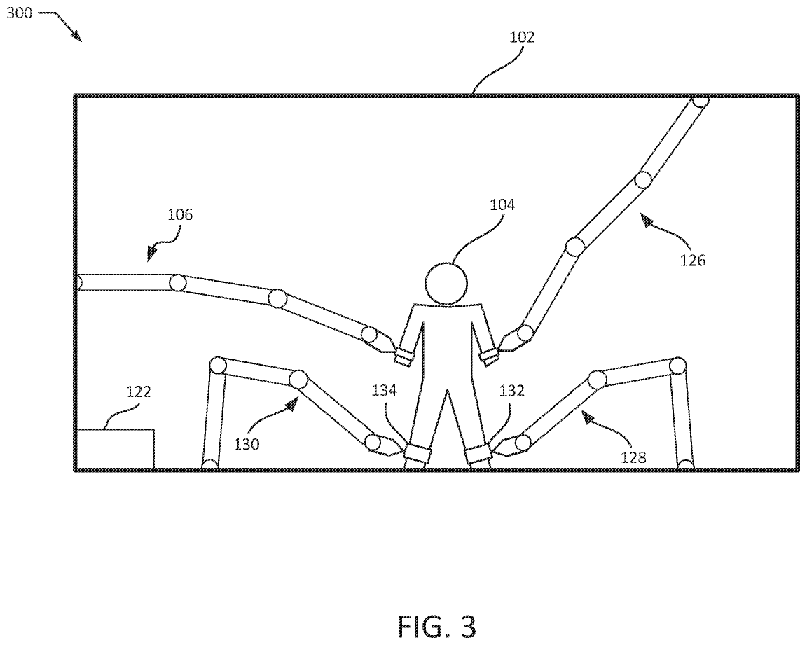

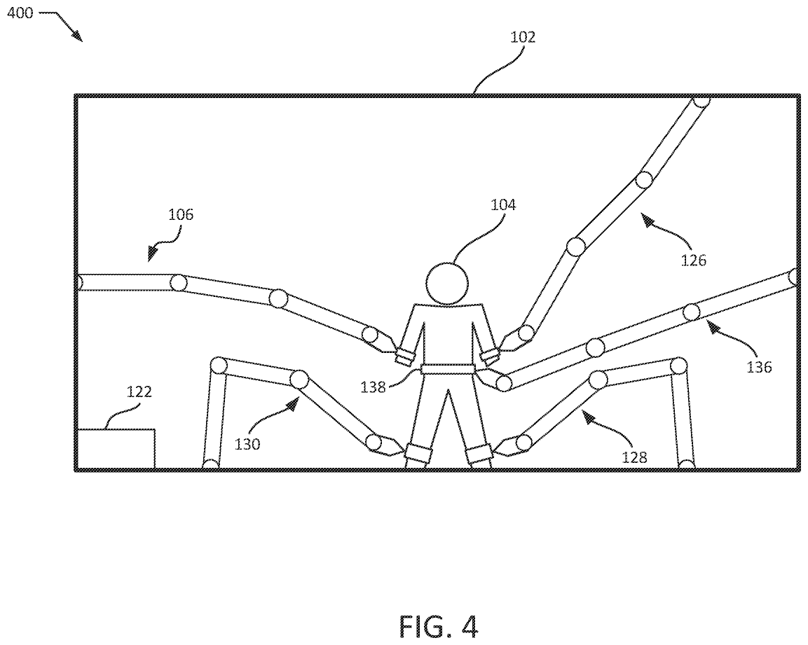

FIGS. 1-4 illustrate robotic haptic feedback systems 100, 200, 300, 400 according to an exemplary embodiment of the present disclosure. The haptic feedback systems 100, 200, 300, 400 may be designed to address one or more of the above-discussed shortcomings of existing haptic feedback systems. Starting with FIG. 1, the haptic feedback system 100 includes a robotic arm 106 that is attached to a user 104. The user 104 may be interacting with a virtual environment implemented by a computing device, such as a virtual reality environment. The robotic arm 106 includes a plurality of robotic links 108, 110, 112 attached together by multiple robotic joints 114, 116, 118. The end effector 113 of robotic arm 106 may be capable of movement with multiple degrees of freedom in Cartesian space. For example, the robotic joints 114, 116, 118 may include one or more sensors (e.g., force sensors, torque sensors, position sensors) and motors configured to rotate each of the robotic links 108, 110, 112 into a desired orientation and/or to apply a desired force or torque. In particular, the robotic arm 106 may be communicatively coupled to a controller 122 that issues commands to control movement of the robotic arm 106. An end effector 113 of the robotic arm 106 is attached to the user 104. In particular, the end effector 113 may be physically connected to a limb of the user, such as the user's 104 arm as depicted. In certain instances, the end effector 113 may be physically connected to a garment 120 or other apparatus that is worn by the user 104. As depicted, the end effector 113 is physically connected to a bracelet worn near the hand of the user 104. In certain implementations, the end effector may further include force and/or torque sensors, similar to the robotic joints. In additional or alternative implementations, these sensors may be omitted.

It should be understood, the number of links and joins of the robotic arm 106 is merely illustrative, and it may be determined based on actual requirement. For example, when the end effector of the robotic arm is required to provide six degrees of freedom, the robotic arm may include six (or more) rotary joints and six (or more) corresponding links. For example, when the end effector of the robotic arm is required to provide only three degrees of freedom, the robotic arm may include only three rotary joints and three corresponding links.

In the system 100, a single robotic arm 106 is connected to a single point on the user 104. However, in various implementations, multiple robotic arms may be used. For example, and the haptic feedback system 200, a second robotic arm 126 is physically connected to a second garment 124 (e.g., a bracelet) worn on the user's 104 other arm. As another example, in the haptic feedback system 300, two additional robotic arms 128, 130 are connected to garments 132, 134 (e.g., ankle bracelets) worn on the user's 104 legs. As a further example, in the haptic feedback system 400, a fifth robotic arm 136 is physically connected to a garment 138 (e.g., a belt) attached to the user's 104 waist.

In each of these embodiments, and as explained further below, one or more controllers 122 may be communicatively coupled to the robotic arms 106, 126, 128, 130, 136 to apply forces and/or torque to the user 104 at one or more points on the user's 104 body (e.g., depending on the robotic arm 106, 126, 128, 130, 136 used to apply the force/torque). In various implementations, a single controller 122 may be used to control all of the robotic arms 106, 126, 128, 130, 136. In additional or alternative implementations, separate controllers may be used to control different robotic arms (e.g., each robotic arm 106, 126, 128, 130, 136 may have its own corresponding controller). Furthermore, although the controller 122 is depicted as a separate device communicatively coupled to the robotic arms 106, 126, 128, 130, 136, in certain implementations, the controller 122 may be contained within the robotic arms 106, 126, 128, 130, 136.

Furthermore, the example attachment points and garments 120, 124, 132, 134, 138 worn by the user 104 are merely exemplary. In practice, different types of garments may be used. For example, the garment may include one or more of a glove, a hat, a head wrap, a shoe, a sleeve, a belt, a vest, a helmet, and/or a neck wrap. Similarly, robotic arms may attach to different points of a user's 104 body depending on the implementation. For example, robotic arms may be physically connected to one or more of the user's 104 hand, arm, head, elbow, torso, waist, leg, foot, shoulder, shoulders, and/or neck. Robotic arm may be connected to an individual limb of the user (e.g., two or more robotic arms may connect to a user's 104 arm). Additionally or alternatively, individual robotic arms may connect to more than one limb or more than one point on a user 104.

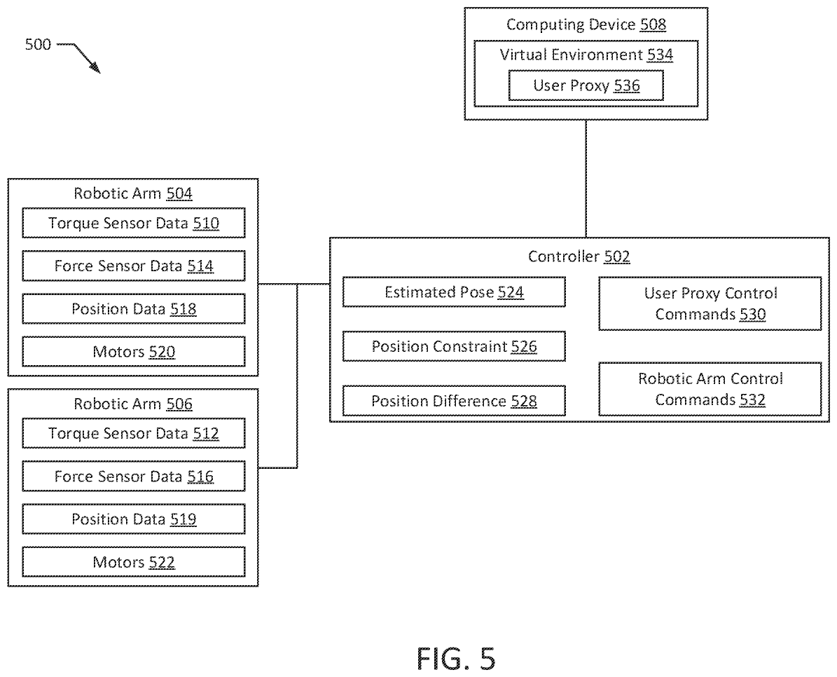

FIG. 5 illustrates a system 500 for controlling a robotic haptic feedback system according to an exemplary embodiment of the present disclosure. In particular, the system 500 may be used to control one or more robotic arms 106, 126, 128, 130, 136 within a haptic feedback system, such as the haptic feedback systems 100, 200, 300, 400. In particular, the system 500 includes robotic arms 504, 506, which may be exemplary implementations of one or more of the robotic arms 106, 126, 128, 130, 136, and a controller 502, which may be an exemplary implementation of the controller 122.

The robotic arms 504, 506 may be physically connected to a user in order to provide haptic feedback to the user. For example, robotic arms 504, 506 may be physically connected to the user according to any of the configurations discussed above in connection with the haptic feedback systems 100, 200, 300, 400. The user may be interacting with a virtual environment 534 implemented by a computing device 508. In various implementations, the virtual environment 534 may include a three-dimensional virtual environment, such as a three-dimensional virtual environment that the user interacts with using a virtual reality system and/or a three-dimensional virtual environment that the user navigates using an input device via a two-dimensional display (e.g., television, computing monitor, and/or other display). In particular, the user may control or otherwise manipulate user proxy 536 within the virtual environment 534. For example, the virtual environment 534 may be a videogame, and the user proxy 536 may be a character manipulated by the user within the videogame. As another example, the virtual environment 534 may represent a virtual conferencing platform, and the user proxy 536 may be an avatar or other representation of the user within the virtual conferencing platform (e.g., visible by other users of the virtual conferencing platform).

The robotic arms 504, 506 contain sensor data, including torque sensor data 510, 512, force sensor data 514, 516, and position data 518, 519. The sensor data may be received from one or more sensors (e.g., torque sensors, force sensors, position sensors) within the robotic arms 504, 506. For example, one or more torque sensors, force sensors, and/or position sensors may be located within robotic joints of the robotic arms 504, 506. In particular implementations, the sensors may be implemented as high-speed sensors (e.g., with sampling frequencies greater than or equal to 25 kHz, such as 25-50 kHz). The robotic arms 504, 506 further can train motors 520, 522, which may be used to control movement of the robotic arms 504, 506. For example, the motors 520, 522 may be located within robotic joints of the robotic arms 504, 506, and may respond to control signals from the controller 502 to move, rotate, or otherwise manipulate robotic links of the robotic arms 504, 506.

The robotic arms 504, 506 and the computing device 508 are communicatively coupled to a controller 502. The controller 502 may be configured to receive information from the robotic arms 504, 506 and the computing device 508 and to generate control commands. For example, the controller 502 may generate robotic arm control commands 532 to control operation of the robotic arms 504, 506 (e.g., to provide haptic feedback to the user). As another example, the controller 502 may generate user proxy control commands 530 for the computing device 508 (e.g., to control the user proxy 536 within the virtual environment 534 according to movements of the user).

In particular, the controller 502 may receive sensor data (e.g., torque sensor data 510, 512, force sensor data 514, 516, and/or position data 518, 519) from the robotic arms 504, 506. In particular implementations, this sensor data may be received on a high-frequency basis. Based on the sensor data, the controller 502 may determine an estimated pose 524 for the user. For example, the controller 502 may aggregate position data 518, 519 to determine the estimated pose 524. For example, the controller 502 may store an association between each of the robotic arms 504, 506 and corresponding limbs of the user. The controller 502 may then be able to associate position data 518, 519 from the robotic arms with the corresponding limbs of the user and may be able to determine an estimate of the user's pose based on the known, associated positions of the corresponding limbs.

The torque sensor data 510, 512, the force sensor data 514, 516 and the position data 518, 519 of the robotic arms 504, 506 may be acquired in different ways. For example, the torque sensor data 510, 512 and/or the force sensor data 514, 516 may be acquired with the implementation of force/torque sensors embedded in the joints of the robotic arms 504, 506, or with a multi-DOF (degree of freedom) force/torque sensor installed on the end effector of the robotic arms 504, 506. Alternatively or additionally, the torque sensor data 510, 512 and/or the force sensor data 514, 516 may be acquired from current data of motors of the joints. For example, the position data 518, 519 of the robotic arms 504, 506 may be acquired by using position encoders embedded in the joints of the robotic arms 504, 506. Alternatively or additionally, the position data 518, 519 of the robotic arms 504, 506 may be acquired with an external camera and a corresponding image identifying system.

As the estimated pose 524 changes over time, the controller 502 may generate user proxy control commands for the user proxy 536. For example, as the user changes positioning and pose over time, the user proxy control commands 530 may be generated to correspondingly update the positioning and pose of the user proxy 536 within the virtual environment. For example, the user proxy control commands 530 may be generated as movement commands for the user proxy 536 within the virtual environment 534 (e.g., keypresses, joystick movements, and the like). In particular, the controller 502 may compute a position difference 528 by comparing the estimated pose 524 to pose information for the user proxy 536. In such instances, the user proxy control commands 530 may be generated to correctly position the user proxy 536 (e.g., based on the magnitude and direction of position differences indicated by the position difference 528.

In certain instances, the controller 502 may generate and issue robotic arm control commands 532 as well. For example, in general operation, the robotic arms 504, 506 may be configured to generally follow the movements of the user (e.g., based on physical inputs received via the physical connections between the robotic arms 504, 506 and the user). However, in certain instances, a position constraint 526 may be received from the computing device 508. For example, the position constraint 526 may be received when a user proxy 536 is unable to move to particular positions within the virtual environment 534 (e.g., as all or part of the user proxy 536 approaches an object, character, or another user's proxy within the virtual environment 534). As one specific example, the user may interact with an object or NPC (non-playable character) within the virtual environment 534 and may be unable to move beyond the object or NPC (e.g., to avoid clipping through). As another example, the user may interact with another user within the virtual environment 534, represented as another user proxy, and may be unable to move beyond the other user's proxy. In such instances, where the controller 502 has received one or more position constraints 526, the controller 502 may compare the estimated pose 524 to the position constraint 526 and may generate the robotic arm control commands 532 based on this comparison. In particular, where the estimated pose 524 approaches, abuts, and/or intersects with all or part of the position constraint 526, the controller 502 may generate robotic arm control commands 532 to apply haptic feedback to the user. As a particular example, as the user's estimated pose 524 approaches a position constraint 526 representative of a wall or other flat surface within the virtual environment 534, the controller 502 may generate robotic on control commands to apply haptic feedback orthogonal to the surface, as indicated by the position constraint 526. The robotic arm control commands 532 may be generated based on the received force and torque sensor data 510, 512, 514, 516. For example, the force and torque applied to the user's limb may increase depending on how hard or how quickly the user is approaching the position constraint 526. Of course, it should be appreciated that various safety constraint in conditions may be in place. For example, torque and/or force applied to a user may be controlled not to exceed a certain predetermined threshold. As another example, lower forces and torques may be used when the user is moving quickly as compared to slower movements (e.g., to prevent sudden stops in other injuries to the user).

In various implementations, because the sensors within the robotic arms 504, 506 are fast-sampling and/or high-frequency sensors, the sensor data 510, 512, 514, 516, 518, 519 may be received at a fast enough rate that the controller 502 may operate as a closed-loop controller for the robotic arms. Furthermore, the robotic arms 504, 506 may include kinematics (e.g., motors and other kinematic components) arranged in a series configuration instead of a parallel configuration, which may enable the robotic arms 504, 506 to apply greater torques and forces to a user.

In the above-discussed examples, the user proxy 536 was described as occurring within a virtual environment 534 implemented by the computing device 508. In practice, the controller 502 may be used to control user proxies in other types of environments. For example, in various instances, the user proxy 536 may be within a physical environment (e.g., a physical environment that is physically separate from the user robotic arms 504, 506. As a specific example, the user proxy 536 may be a robotic arm or other robotic device located in a physical environment separate from the physical environment that contain robotic arms 504, 506 and the user. In such instances, similar techniques may be used to control the operation of the physical user proxy within the physical environment (e.g., based on physical constraints 526 encountered by the physical user proxy while moving throughout its corresponding physical environment).

In practice, the controller 502 and/or the computing device 508 may be implemented by one or more computing systems, such as the computing systems 800 described in greater detail below. For example, the controller 502 and/or the computing device 508 may be implemented as one or more laptop computers, personal computers, tablet computers, smart phones, wearable computing devices, and/or other computing devices. Furthermore, the controller 502 and/or the computing device 508 may include a memory and a processor configured to implement one or more operational features of the controller 502 and/or the computing device 508. For example, the memory may store instructions which, when executed by the processor, cause the processor to implement one or more operational features of the controller 502 and/or the computing device 508. Furthermore, the robotic arms 504, 506, the controller 502, and/or the computing device 508 may communicate using one or more computing networks. For example, the robotic arms 504, 506, the controller 502, and/or the computing device 508 may communicate using one or more wired or wireless network interfaces and one or more public or private computing networks. In one example, the robotic arm 504, 506 and the controller 502 may communicate using a private network, and the computing device 508 and controller 502 may communicate using a public network (e.g., the Internet). Additionally or alternatively, the robotic arms 504, 506 may be directly communicatively coupled (e.g., using a direct data connection) to the controller 502.

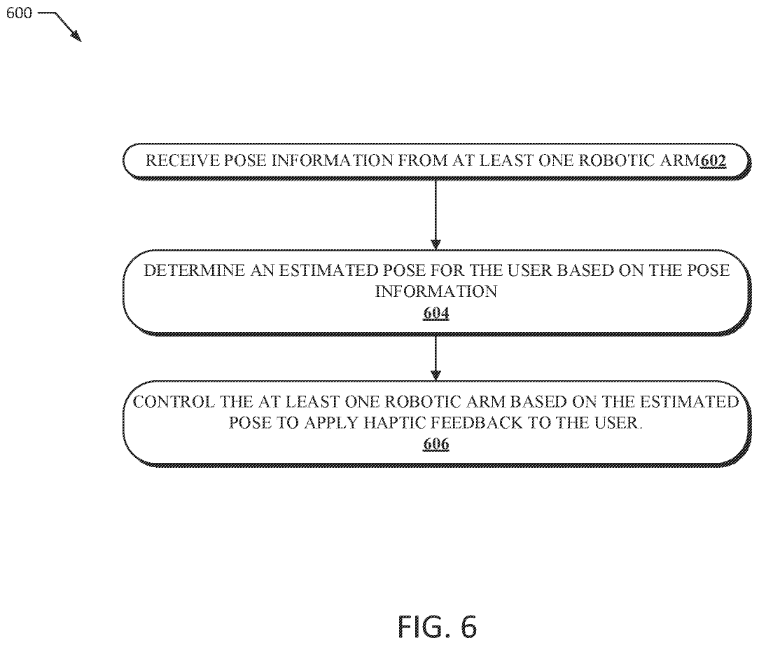

FIG. 6 illustrates a method 600 for controlling a robotic haptic feedback system according to an exemplary embodiment of the present disclosure. The method 600 may be performed to control one or more robotic arms that are physically connected to a user to provide haptic feedback to a user based on a user proxy within an environment (e.g., a virtual environment, a physical environment). The method 600 may be implemented on a computer system, such as the system 500. For example, the method 600 may be implemented by the controller 502. The method 600 may also be implemented by a set of instructions stored on a computer readable medium that, when executed by a processor, cause the computer system to perform the method 600. For example, all or part of the method 600 may be implemented by a processor and a memory of the controller 502. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks described may be optional.

The method 600 may begin with receiving force information, torque information, and pose information from at least one robotic arm (block 602). For example, the controller 502 may receive force sensor data 514, 516, torque sensor data 510, 512, and position data 518, 519 from one or more robotic arms 504, 506. The robotic arms 504, 506 may be physically coupled to a user 104. For example, the robotic arms 504, 506 may be physically coupled to one or more limbs or other portions of the user (e.g., using one or more garments or other connection devices). In specific example, the robotic arms 504, 506 may be physically connected to the user 104 according to one or more of the configurations depicted the haptic feedback systems 100, 200, 300, 400.

An estimated pose may be determined for the user based on the pose information (block 604). For example, the controller 502 may determine an estimated pose 524 based on the position data 520, 519 received from the robotic arms 504, 506. As explained above, the controller 502 may associate position data 51, 519 for particular robotic arms with corresponding limbs or other portion of the user 104 to which the robotic arms 504, 506 are connected. Accordingly, the controller 502 may then estimate a pose based on the one or more known, associated locations for the user's 104 limbs.

The at least one robotic arm may be controlled based on the estimated pose to apply haptic feedback to the user (block 606). For example, the controller 502 may control the at least one robotic arm 504, 506 based on the estimated pose 524 to apply haptic feedback to the user 104. In particular, the controller 502 may compare the estimated pose 524 to the one or more position constraints 526 received from a computing device 508 associated with the environment in which the user proxy 536 is located (e.g., a corresponding virtual environment and/or physical environment). If the controller 502 determines that the estimated pose 524 violates or is likely to violate the position constraints 526, the controller 502 may generate one or more robotic arm control commands 532 to apply haptic feedback to the user 104 (e.g., according to one or more known force and torque values indicated by the force sensor data 514, 516 in the torque sensor data 510, 512).

In this manner, the method 600 thus enables a closed-loop controller to receive sensor data in a high frequency from robotic arms that are physically connected to a user to apply feedback to the user. Such systems may improve the quality of haptic feedback received by the user and enable the user to more freely navigate a corresponding physical or virtual environment. In particular, where the user proxy is located within a physical environment, improved haptic feedback applied to the user may improve the user's ability to control the corresponding user proxy (e.g., corresponding robotic arm or other system) within the physical environment. This may improve the precision and quality of movements that are capable of being reproduced of physically disparate locations.

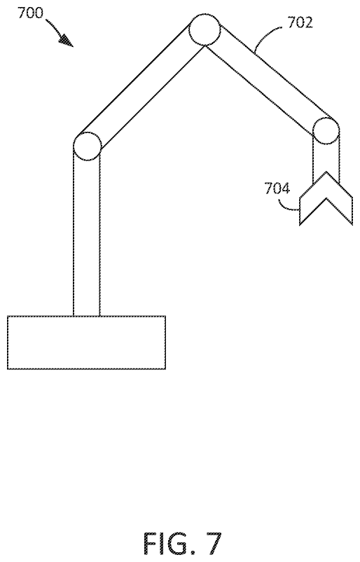

FIG. 7 depicts a robotic arm 700 according to an exemplary embodiment of the present disclosure. The robotic arm 700 may be communicatively coupled with the system 500 (e.g., the controller 502) and may be an exemplary implementation of the robotic arms 106, 126, 128, 130, 136, 504, 506. The robotic arm 700 may include multiple robotic arm segments 702 and an end effector 704. The end effector 704 may include a gripper, in which one or more sensors (e.g., force and/or torque sensors) may be installed. In certain instances, as explained above, the end effector 704 may be connected to a user in order to apply haptic feedback to the user. In other examples, the end effector 604 may be any other suitable tool that utilizes any suitable sensor(s) as described in the present disclosure. In some embodiments, the sensor(s) to detect changes in force and/or torque may be alternatively or additionally be installed in the joint actuator of the robotic arm segments 702.

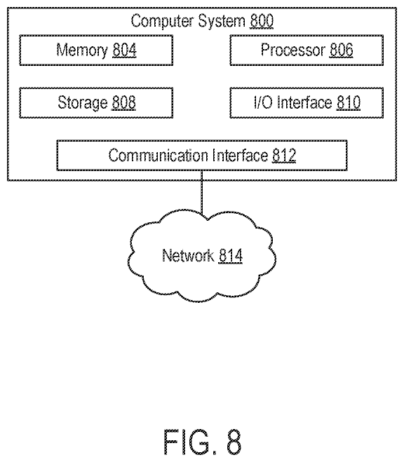

FIG. 8 illustrates an example computer system 800 that may be utilized to implement one or more of the devices and/or components discussed herein, such as the system 500, the controllers 122, 502, and/or the computing device 508. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. In particular embodiments, the processor 806 may include one or more internal caches for data, instructions, or addresses. This disclosure contemplates the processor 806 including any suitable number of any suitable internal caches, where appropriate. As an example and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions; the results of previous instructions executed by the processor 806 that are accessible to subsequent instructions or for writing to memory 804 or storage 808; or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 806. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808 or another source (such as another computer system 800) to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate accesses to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person (i.e., a user) and computer system 800. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example and not by way of limitation, communication interface 812 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 814 and any suitable communication interface 812 for the network 814. As an example and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementations, this disclosure contemplates any suitable communication interface implementation.

The computer system 802 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A haptic feedback system comprising:
at least one robotic arm, the robotic arm comprising at least one joint and an end effector, wherein the end effector is physically coupled to a user;
an external data connection to a computing device associated with an environment; and
a controller configured to:
receive pose information of the at least one robotic arm;
determine an estimated pose for the user based on the pose information; and
control the robotic arm based on the estimated pose to apply haptic feedback to the user via the end effector.

2. The haptic feedback system of claim 1, wherein the controller is further configured to control a proxy of the user within the environment based on the estimated position.

3. The haptic feedback system of claim 1, wherein the controller is further configured to:
receive force and torque information via the external data connection; and
control the robotic arm to limit at least one of a force applied to the user and a torque applied to the user.

4. The haptic feedback system of claim 3, wherein the robotic arm further comprises sensors, and where controlling the robotic arm based on the force and torque information comprises measuring at least one of a force and a torque applied to the user at the end effector using the sensors.

5. The haptic feedback system of claim 4, wherein the controller is a closed-loop controller and receives data measured by the sensors.

6. The haptic feedback system of claim 4, wherein the sensors are arranged in a series orientation.

7. The haptic feedback system of claim 1, wherein the environment is a virtual environment.

8. The haptic feedback system of claim 1, wherein the environment is a physical environment that is physically separated from the haptic feedback system.

9. The haptic feedback system of claim 1, wherein the end effector is physically connected to the end of a limb of the user.

10. The haptic feedback system of claim 1, wherein the end effector is physically connected to a garment worn by the user.

11. The haptic feedback system of claim 10, wherein the garment includes one or more of a glove, a shoe, a sleeve, a belt, a vest, a helmet, and/or a neck wrap.

12. The haptic feedback system of claim 1, further comprising multiple robotic arms that are physically coupled to the user at multiple points.

13. The haptic feedback system of claim 1, wherein the end effector is capable of movement with 6 degrees of freedom.

14. The haptic feedback system of claim 1, wherein the at least one robotic arm is further physically coupled to a fixed structure surrounding the user.

15. A method comprising:
receiving pose information from at least one robotic arm, wherein the at least one robotic arm is physically coupled to a user;
determining an estimated pose for the user based on the pose information; and
controlling the at least one robotic arm based on the estimated pose to apply haptic feedback to the user.

16. The method of claim 15, wherein the controller is further configured to control a proxy of the user within an environment based on the estimated position.

17. The method of claim 16, wherein the environment is a virtual environment.

18. The method of claim 15, wherein the robotic arm comprises sensors, and where controlling the robotic arm comprises measuring at least one of a force and a torque applied to the user using the sensors.

19. The method of claim 18, wherein the controller is a closed-loop controller and receives data measured by the sensors.

20. The method of claim 18, wherein the sensors are arranged in a series orientation.
